(19) United States
(12) Patent Application Publication
(10) Pub. No.: US 2026/0018183 A1
(43) Pub. Date: Jan. 15, 2026

(54) ECHO CANCELLATION DEVICE AND ECHO CANCELLATION METHOD

(71) Applicant: PANASONIC INTELLECTUAL PROPERTY MANAGEMENT CO., LTD., Osaka (JP)

(72) Inventors: Hiromasa OHASHI, Osaka (JP); Junji ARAKI, Osaka (JP)

(73) Assignee: PANASONIC INTELLECTUAL PROPERTY MANAGEMENT CO., LTD., Osaka (JP)

(21) Appl. No.: 19/115,863

(22) PCT Filed: Aug. 30, 2023
(86) PCT No.: PCT/JP2023/031654

§ 371 Date: Mar. 27, 2025

(30) Foreign Application Priority Data
Sep. 28, 2022 (JP) 2022-155170

(51) Int. Cl. G10L 21/0232; G10L 21/0208; G10L 21/034; G10L 21/0364; G10L 25/18

(52) U.S. Cl. CPC G10L 21/0232; G10L 21/034; G10L 21/0364; G10L 25/18; G10L 2021/02082

(57) ABSTRACT

An echo canceller generates a microphone signal, updates an adaptive filter used for estimating an echo signal, generates a pseudo-echo signal based on an output signal and the adaptive filter, removes the pseudo-echo signal from the microphone signal and generates an echo-removed signal, determines whether a target speech signal is included in the echo-removed signal, adjusts a gain of the echo-removed signal based on a determination result, and generates the output signal based on the adjusted echo-removed signal.

### TECHNICAL FIELD

The present disclosure relates to an echo canceller and an echo cancellation method.

### BACKGROUND ART

In an audio conference device in which a plurality of units each including a microphone and a speaker are connected to each other, there is known a technique for reducing a delay of an amplified speech.

Patent Literature 1 discloses a technique in which, when a microphone is off and does not pick up a desired speech signal, no speech signal collected by the microphone is output to outside, and a speech signal received from the outside is supplied to a speaker; when the microphone is on and picks up the desired speech signal, the speech signal collected by the microphone is supplied to the outside, and no speech signal received from the outside is supplied to the speaker.

### CITATION LIST

### Patent Literature

Patent Literature 1: JP2008-147822A

### SUMMARY OF INVENTION

### Technical Problem

However, between a first unit and a second unit adjacent to each other in an audio conference device including a plurality of units connected to each other in Patent Literature 1, a speech goes around from a speaker of the first unit to a microphone of the second unit and an echo sound is generated, which cannot be sufficiently removed.

An object of the present disclosure is to provide a technique that can sufficiently remove an echo sound.

### Solution to Problem

According to an aspect of the present disclosure, there is provided an echo canceller for removing an echo sound that is a sound output from a speaker, propagates through space and is input to a microphone, the echo canceller including: a microphone signal generation unit configured to generate a microphone signal based on a sound received from the microphone; an adaptive filter update unit configured to update an adaptive filter used for estimating an echo signal that is a signal related to the echo sound; a pseudo-echo signal generation unit configured to generate a pseudo-echo signal based on an output signal that is a signal related to a sound output from the speaker and the adaptive filter; an echo signal removing unit configured to remove the pseudo-echo signal from the microphone signal and generate an echo-removed signal; a target speech detection unit configured to determine whether a target speech signal that is a signal different from the echo signal is included in the echo-removed signal; a gain adjustment unit configured to adjust a gain of the echo-removed signal based on a determination result by the target speech detection unit; and an output signal generation unit configured to generate the output signal based on the echo-removed signal adjusted by the gain adjustment unit.

According to an aspect of the present disclosure, there is provided an echo cancellation method for removing an echo sound that is a sound output from a speaker, propagates through space and is input to a microphone, the method including: a microphone signal generation step of generating a microphone signal based on a sound received from the microphone; an adaptive filter update step of updating an adaptive filter used for estimating an echo signal that is a signal related to the echo sound; a pseudo-echo signal generation step of generating a pseudo-echo signal based on an output signal that is a signal related to a sound output from the speaker and the adaptive filter; an echo signal removing step of removing the pseudo-echo signal from the microphone signal and generating an echo-removed signal; a target speech determination step of determining whether a target speech signal that is a signal different from the echo signal is included in the echo-removed signal; a gain adjustment step of adjusting a gain of the echo-removed signal based on a determination result by the target speech determination step; and an output signal generation step of generating the output signal based on the echo-removed signal adjusted by the gain adjustment step.

These comprehensive or specific aspects may be implemented by a system, a device, a method, an integrated circuit, a computer program, a recording medium, or any combination of the system, the device, the method, the integrated circuit, the computer program, and the recording medium.

### Advantageous Effects of Invention

According to a technique of the present disclosure, an echo sound can be sufficiently removed.

### BRIEF DESCRIPTION OF DRAWINGS

FIG. 1 is a block diagram showing a configuration example of a speech input and output system according to Embodiment 1;

FIG. 2 is a block diagram showing a configuration example of an echo canceller according to Embodiment 1;

FIG. 3 shows details of a reference signal storage unit, a standard value calculation unit, a standard value storage unit, and an adaptive filter update unit according to Embodiment 1;

FIG. 4A is a block diagram showing a first example of a configuration of the echo canceller according to Embodiment 2;

FIG. 4B is a block diagram showing a second example of the configuration of the echo canceller according to Embodiment 2;

FIG. 5A is a flowchart showing a first example of processing of a gain adjustment unit according to Embodiment 2;

FIG. 5B is a flowchart showing a second example of the processing of the gain adjustment unit according to Embodiment 2;

FIG. 6 is a flowchart showing a processing example for removing an echo signal in a frequency domain according to Embodiment 2;

FIG. 7 is a block diagram showing a third example of the configuration of the echo canceller according to Embodiment 2; and

FIG. 8 is a flowchart showing a processing example of a target speech detection unit according to Embodiment 2.

### DESCRIPTION OF EMBODIMENTS

Hereinafter, embodiments of the present disclosure will be described in detail with reference to drawings as appropriate. However, unnecessarily detailed description may be omitted. For example, detailed description of already well-known matters and redundant description of substantially the same configuration may be omitted. This is to avoid redundancy of following description and facilitate understanding of those skilled in the art. The accompanying drawings and the following description are provided for those skilled in the art to sufficiently understand the present disclosure, which are not intended to limit the subject matter described in the claims.

### Embodiment 1

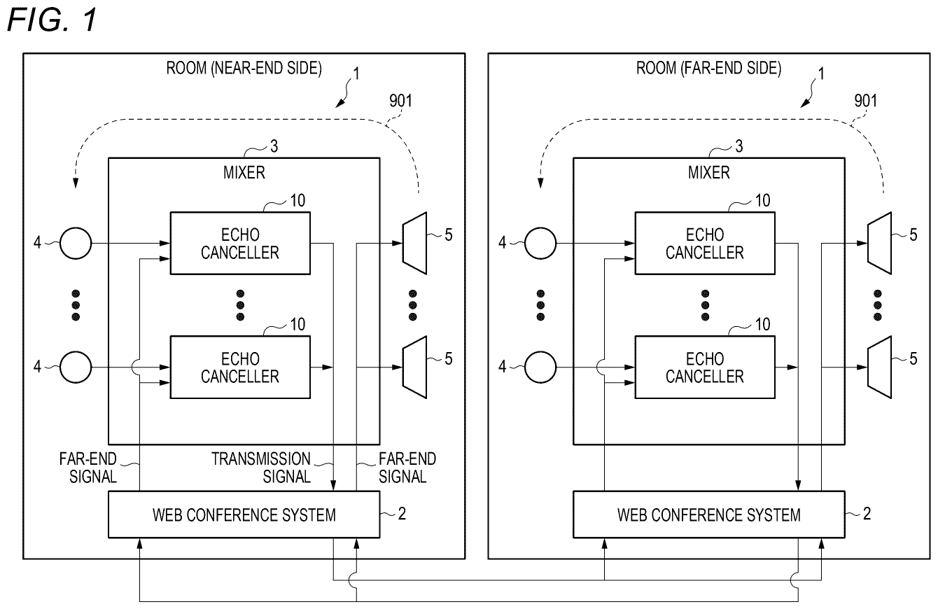

FIG. 1 is a block diagram showing a configuration example of a speech input and output system 1 according to Embodiment 1.

The speech input and output system 1 includes a WEB conference system 2, a mixer 3, at least one microphone 4, and at least one speaker 5. For example, as shown in FIG. 1, the speech input and output system 1 in a near-end-side room and the speech input and output system 1 in a far-end-side room are connected via a communication network (not shown), and a user in the near-end-side room and a user in the far-end-side room can perform a remote conference. Hereinafter, the speech input and output system 1 in the near-end-side room will be described, and the following description also applies to the speech input and output system 1 in the far-end-side room.

The WEB conference system 2 is connected to another WEB conference system 2 via a communication network (not shown). The WEB conference system 2 may be a dedicated device, a server, or a PC. The WEB conference system 2 in the far-end-side room may be a PC, and the microphone 4 and the speaker 5 on a far-end side may be a headset connected to the PC.

The mixer 3 is connected to the WEB conference system 2 via a communication network. The communication network may be, for example, a wired local area network (LAN), a wireless LAN, the Internet, or a virtual private network (VPN). The mixer 3 may be a rack mount mixer.

At least one microphone 4 and at least one speaker 5 are connected to the mixer 3. The mixer 3 includes at least one echo canceller 10. The echo canceller 10 may be installed on a DSP board that can be additionally mounted on the mixer 3.

When a speech of the user on the far-end side input to the mixer 3 from the WEB conference system 2 is output from the speaker 5, the output sound is transmitted through space and input to the microphone 4 as indicated by a dotted arrow 901, and a signal of the input speech is transmitted to the far-end side via the WEB conference system 2. At this time, a speech uttered by the user on the far-end side returns to the far-end side again, and accordingly an echo sound is generated.

In the present embodiment, a signal including the speech uttered by the user on the far-end side, which is a signal transmitted from the far-end side to a near-end side, is referred to as a far-end signal. A signal transmitted from the mixer 3 on the near-end side to the far-end side is referred to as a transmission signal.

The echo canceller 10 removes the speech uttered by the user on the far-end side included in an input speech received from the microphone 4, and outputs a transmission signal including a speech excluding the removed speech (hereinafter, referred to as echo-removed speech) to the WEB conference system 2. The output transmission signal is transmitted to the WEB conference system 2 on the far-end side and output from the speaker 5 on the far-end side. Accordingly, an echo in the speaker 5 on the far-end side can be prevented.

However, when the number of connected microphones 4, position and environment of the microphone 4, and the like change, an echo sound may also change. Hereinafter, the echo canceller 10 that can immediately remove an echo sound even when the environment of the microphone 4 changes in this manner will be described in detail.

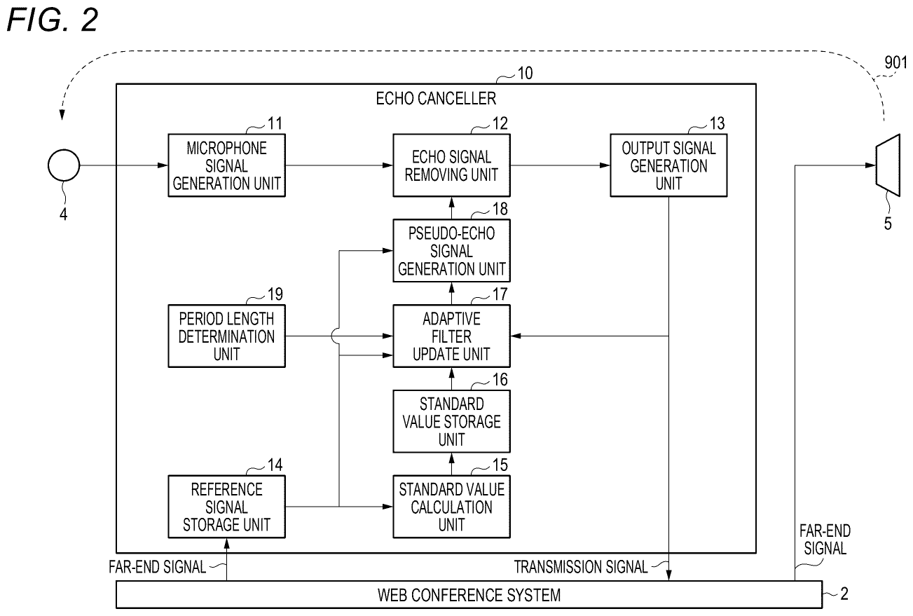

FIG. 2 is a block diagram showing a configuration example of the echo canceller 10 according to Embodiment 1.

The echo canceller 10 includes a microphone signal generation unit 11, an echo signal removing unit 12, an output signal generation unit 13, a reference signal storage unit 14, a standard value calculation unit 15, a standard value storage unit 16, an adaptive filter update unit 17, a pseudo-echo signal generation unit 18, and a period length determination unit 19.

The microphone signal generation unit 11, the echo signal removing unit 12, the output signal generation unit 13, the standard value calculation unit 15, the adaptive filter update unit 17, the pseudo-echo signal generation unit 18, and the period length determination unit 19 may be implemented by a semiconductor circuit included in the echo canceller 10 or may be implemented by a computer program executed by a processor included in the echo canceller 10. The reference signal storage unit 14 and the standard value storage unit 16 may be a volatile or non-volatile memory included in the echo canceller 10.

The microphone signal generation unit 11 generates and outputs a microphone signal m[I] based on the input speech input to the microphone 4. Here, i represents a time index.

The echo signal removing unit 12 removes a pseudo-echo signal y\hat{ }[i] generated by the pseudo-echo signal generation unit 18 described later from the microphone signal m[i] output from the microphone signal generation unit 11, and generates and outputs an echo-removed signal.

The output signal generation unit 13 generates and outputs a transmission signal e[i] based on the echo-removed signal output from the echo signal removing unit 12. The output signal generation unit 13 may directly output the echo-removed signal as the transmission signal, or may generate and output the transmission signal after performing prescribed processing on the echo-removed signal.

The reference signal storage unit 14 stores a far-end signal equivalent to a far-end signal output from the WEB conference system 2 to the speaker 5 as a reference signal x[i] for a prescribed period. Details of the reference signal storage unit 14 will be described later.

The standard value calculation unit 15 calculates a standard value using a reference signal stored in the reference signal storage unit 14. The standard value calculation unit 15 may calculate a plurality of standard values corresponding to a plurality of periods different from each other in parallel. Then, the standard value calculation unit 15 stores the plurality of calculated standard values corresponding to the plurality of periods in the standard value storage unit 16. Details of the standard value calculation unit 15 will be described later.

The standard value storage unit 16 stores the plurality of standard values corresponding to the plurality of periods calculated by the standard value calculation unit 15. Details of the standard value storage unit 16 will be described later.

The adaptive filter update unit 17 updates (trains) an adaptive filter using any one standard value of the plurality of standard values stored in the standard value storage unit 16, the reference signal, and the transmission signal.

The pseudo-echo signal generation unit 18 generates a pseudo-echo signal using the reference signal and the adaptive filter updated by the adaptive filter update unit 17. The pseudo-echo signal is used in the echo signal removing unit 12 described above.

The period length determination unit 19 determines a period length for selecting a standard value used for the adaptive filter. The adaptive filter update unit 17 acquires a standard value corresponding to the period length determined by the period length determination unit 19 from the standard value storage unit 16 and uses the standard value. The period length determination unit 19 may determine the period length based on the number of microphones 4 connected to the mixer 3. When the number of microphones 4 connected to the mixer 3 changes, the period length determination unit 19 may redetermine the period length. When the position or the surrounding environment of the microphone 4 connected to the mixer 3 changes, the period length determination unit 19 may redetermine the period length.

A correspondence relation between the number of connected microphones 4 and the period length may be determined in advance. The correspondence relation may be different for each environment in which the microphone 4 is present. For example, in an environment where the microphone 4 is present, which period length has a highest echo removal effect may be measured in advance while changing the number of connected microphones 4 and the period length, and the correspondence relation between the number of connected microphones 4 and the period length may be determined based on a measurement result thereof.

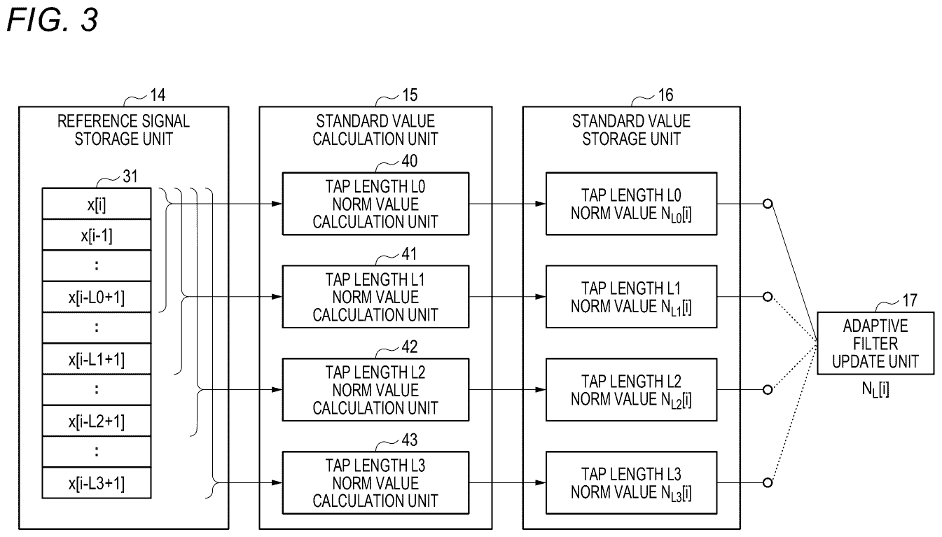

FIG. 3 shows details of the reference signal storage unit 14, the standard value calculation unit 15, the standard value storage unit 16, and the adaptive filter update unit 17 according to Embodiment 1.

The reference signal storage unit 14 stores reference signals for a prescribed period. The reference signal storage unit 14 may be, for example, a ring buffer 31, and an old reference signal may be sequentially replaced with a new reference signal.

The reference signal storage unit 14 stores, for example, reference signals x[i] to x[i−L3+1] in periods [i] to [i−L3+1]. Here, i represents a time index, and x[i] represents a reference signal at the time index i. L0, L1, L2, and L3 are integers indicating tap lengths, and L0<L1<L2<L3.

The standard value calculation unit 15 calculates a plurality of standard values corresponding to a plurality of tap lengths different from each other in parallel. In the present embodiment, the standard value is a norm value. For example, the standard value calculation unit 15 includes a tap length L0 norm value calculation unit 40, a tap length L1 norm value calculation unit 41, a tap length L2 norm value calculation unit 42, and a tap length L3 norm value calculation unit 43. The tap length L0 norm value calculation unit 40, the tap length L1 norm value calculation unit 41, the tap length L2 norm value calculation unit 42, and the tap length L3 norm value calculation unit 43 may perform calculation processing in parallel. Accordingly, the standard value calculation unit 15 can calculate four norm values at a high speed.

The tap length L0 norm value calculation unit 40 calculates a tap length L0 norm value N_{L0}[i] by the following formula (1).

$$\begin{matrix}[ Math . 1 ] & \\ {N}_{L 0} [ i ] = {\sum }_{n = i - L 0 + 1}^{i} \vert x [ n ] \vert & ( 1 )\end{matrix}$$

The tap length L1 norm value calculation unit 41 calculates a tap length L1 norm value N_{L1}[i] by the following formula (2).

$$\begin{matrix}[ Math . 2 ] & \\ {N}_{L 1} [ i ] = {\sum }_{n = i - L 1 + 1}^{i} \vert x [ n ] \vert & ( 2 )\end{matrix}$$

The tap length L2 norm value calculation unit 42 calculates a tap length L2 norm value N_{L2}[i] by the following formula (3).

$$\begin{matrix}[ Math . 3 ] & \\ {N}_{L 2} [ i ] = {\sum }_{n = i - L 2 + 1}^{i} \vert x [ n ] \vert & ( 3 )\end{matrix}$$

The tap length L3 norm value calculation unit 43 calculates a tap length L3 norm value N_{L3}[i] by the following formula (4).

$$\begin{matrix}[ Math . 4 ] & \\ {N}_{L 3} [ i ] = {\sum }_{n = i - L 3 + 1}^{i} \vert x [ n ] \vert & ( 4 )\end{matrix}$$

The above formula (1) may be calculated by the following formula (5).

$$\begin{matrix}[ Math . 5 ] & \\ {N}_{L 0} [ i ] = {\sum }_{n = i - L 0 + 1}^{i} \vert x [ n ] \vert = {N}_{L 0} [ i - 1 ] + \vert x [ i ] \vert - \vert x [ i - L 0 ] \vert & ( 5 )\end{matrix}$$

This is a method of calculating the tap length L0 norm value N_{L0}[i] by adding an absolute value |x[i]| of a reference signal of a current time index i to a norm value N_{L0}[i−1] calculated at a previous time timing [i−1] and subtracting an absolute value |x[i−L0]| of a reference signal of a time index [i−L0] outside a period. Accordingly, the amount of calculation is reduced as compared with a method of adding absolute values of all reference signals at the tap length L0, and thus a norm value can be calculated at a high speed. The same applies to the tap length L1 norm value N_{L1}[i], the tap length L2 norm value N_{L2}[i], and the tap length L3 norm value N_{L3}[i].

The tap length L0 norm value N_{L0}[i] may be calculated by the following formula (6) instead of the above formula (1). The same applies to the tap length L1 norm value N_{L1}[i], the tap length L2 norm value N_{L2}[i], and the tap length L3 norm value N_{L3}[i].

$$\begin{matrix}[ Math . 6 ] & \\ {N}_{L 0} [ i ] = {\sum }_{n = i - L 0 + 1}^{i} {x}^{2} [ n ] & ( 6 )\end{matrix}$$

The tap length L0 norm value calculation unit 40 stores the calculated tap length L0 norm value N_{L0}[i] in the standard value storage unit 16. The tap length L1 norm value calculation unit 41 stores the tap length L1 calculated norm value N_{L1}[i] in the standard value storage unit 16. The tap length L2 norm value calculation unit 42 stores the calculated tap length L2 norm value N_{L2}[i] in the standard value storage unit 16. The tap length L3 norm value calculation unit 43 stores the calculated tap length L3 norm value N_{L3}[i] in the standard value storage unit 16. Accordingly, N_{L0}[i], N_{L1}[i], N_{L2}[i], N_{L3}[i] are stored in the standard value storage unit 16.

The adaptive filter update unit 17 selects any one of N_{L0}[i], N_{L1}[i], N_{L2}[i], N_{L3}[i] from the standard value storage unit 16 according to the determination by the period length determination unit 19. Hereinafter, the selected tap length is expressed as L, and the selected norm value is expressed as N_{L}[i].

The adaptive filter update unit 17 calculates an update amount Δω₍ᵢ₎[1] of an adaptive filter coefficient by the following formula (7). Here, I represents a tap index, μ[1] represents a step gain corresponding to the tap index 1, and e[i] represents a transmission signal. φ( ) represents a nonlinear function. Examples of φ( ) include an identity function id(x)=x, sign( ) tanh( ) and the like. For example, φ(e[i]) may be tanh(αe[i]). Here, a is a scaling coefficient.

$$\begin{matrix}[ Math . 7 ] & \\ Δ {ω}_{( i )} [ l ] = μ [ l ] \frac{ϕ ( e [ i ] ) x \vert i - l \vert}{{N}_{L} [ i ]} & ( 7 )\end{matrix}$$

The adaptive filter update unit 17 calculates an adaptive filter coefficient ω₍ᵢ₊₁₎[1] by the following formula (8) using the update amount Δω₍ᵢ₎[1] of the adaptive filter coefficient calculated by formula (7). Here, ω₍ᵢ₎[1] indicates an adaptive filter coefficient of an 1-th tap at the time index i.

$$\begin{matrix}[ Math . 8 ] & \\ {ω}_{( i + 1 )} [ l ] = {ω}_{( i )} [ l ] + Δ {ω}_{( l )} [ l ] & ( 8 )\end{matrix}$$

The pseudo-echo signal generation unit 18 generates the pseudo-echo signal y\hat{ }[i] by the following formula (9) using the adaptive filter coefficient calculated by the formula (8).

$$\begin{matrix}[ Math . 9 ] & \\ \hat{y} [ i ] = {\sum }_{l = 0}^{L} ω [ l ] x [ i - l ] & ( 9 )\end{matrix}$$

The echo signal removing unit 12 generates the echo-removed signal (transmission signal) e[i] by the following formula (10) using the pseudo-echo signal y\hat{«}[i] calculated by formula (9). That is, the echo signal removing unit 12 removes the pseudo-echo signal y\hat{ }[i] from the microphone signal m[i] and generates the echo-removed signal (transmission signal) e[i].

$$\begin{matrix}[ Math . 10 ] & \\ e [ i ] = m [ i ] - \hat{y} [ i ] & ( 10 )\end{matrix}$$

The output signal generation unit 13 outputs the echo-removed signal (transmission signal) e[i] generated in this manner to the WEB conference system 2. Accordingly, a transmission signal from which an echo sound is removed can be transmitted.

According to the above-described method, the norm values N_{L0}[i], N_{L1}[i], N_{L2}[i], N_{L3}[i] at different tap lengths at a latest time index i are stored in the standard value storage unit 16. Therefore, in a case in which characteristics of an echo sound are changed when, for example, the number of connected microphones 4 is changed or the environment in which the microphone 4 is present is changed, the adaptive filter update unit 17 can immediately update the adaptive filter so that an echo signal after change can be appropriately removed by selecting an optimum norm value for removing an echo signal having changed characteristics among a plurality of norm values different from each other stored in the standard value storage unit 16. That is, the echo canceller 10 can immediately remove an echo sound even when the characteristics of the echo sound change.

In the above description, the number of tap lengths is four including L0, L1, L2, and L3. Alternatively, the number of tap lengths may be any number equal to or larger than two.

### Summary of Embodiment 1

The following techniques are disclosed in Embodiment 1.

### <Technique A1>

The echo canceller 10 for removing an echo signal related to a sound, which is a speech output from the speaker 5 based on a far-end signal received from a far-end side, propagates through space and is input to the microphone 4, includes: the microphone signal generation unit 11 that generates a microphone signal based on a sound received from the microphone 4; the adaptive filter update unit 17 that updates an adaptive filter used for estimating an echo signal; the reference signal storage unit 14 that stores a far-end signal of a prescribed period as a reference signal; the pseudo-echo signal generation unit 18 that generates a pseudo-echo signal based on the reference signal stored in the reference signal storage unit 14 and the adaptive filter; the echo signal removing unit 12 that removes a pseudo-echo signal from a microphone signal and generates an echo-removed signal; the output signal generation unit 13 that generates a transmission signal based on the echo-removed signal; the standard value calculation unit 15 that calculates a plurality of standard values corresponding to a plurality of period lengths different from each other in parallel based on a reference signal: the standard value storage unit 16 that stores the plurality of standard values calculated by the standard value calculation unit 15; and the period length determination unit 19 that determines one of the plurality of period lengths as a first period length. The adaptive filter update unit 17 acquires, from the standard value storage unit 16, a first standard value corresponding to the first period length determined by the period length determination unit 19, and updates the adaptive filter using the first standard value.

Since the plurality of standard values corresponding to the plurality of period lengths different from each other are stored in the standard value storage unit 16, the adaptive filter update unit 17 can immediately acquire the appropriate first standard value from the standard value storage unit 16 according to the determination of the period length determination unit 19 and update the adaptive filter. That is, the echo canceller 10 can immediately perform appropriate echo removal when an environment of the microphone 4 changes.

### <Technique A2>

In the echo canceller 10 described in technique A1, the period length is a tap length, the standard value is a norm value, and the standard value calculation unit 15 calculates the norm value corresponding to the tap length based on a reference signal corresponding to the tap length.

Accordingly, the plurality of norm values corresponding to the plurality of tap lengths are stored in the standard value storage unit 16.

### <Technique A3>

In the echo canceller 10 according to technique A1 or A2, the period length determination unit 19 determines the first period length based on the number of connected microphones.

Accordingly, the echo canceller 10 can immediately perform appropriate echo removal when the number of connected microphones 4 are changed.

### <Technique A4>

An echo cancellation method for removing an echo signal related to a sound, which is a speech output from the speaker 5 based on a far-end signal received from a far-end side, propagates through space and is input to the microphone 4, includes: a microphone signal generation step of generating a microphone signal based on a sound received from the microphone 4: an adaptive filter updating step of updating an adaptive filter used for estimating an echo signal: a reference signal storage step of storing a far-end signal of a prescribed period in the reference signal storage unit 14 as a reference signal: a pseudo-echo signal generation step of generating a pseudo-echo signal based on the reference signal stored in the reference signal storage unit 14 and the adaptive filter: an echo signal removing step of removing a pseudo-echo signal from a microphone signal and generating an echo-removed signal: an output signal generation step of generating a transmission signal based on the echo-removed signal: a standard value calculation step of calculating a plurality of standard values corresponding to a plurality of period lengths different from each other in parallel based on a reference signal: a standard value storage step of storing the plurality of standard values calculated by the standard value calculation step in the standard value storage unit 16; and a period length determining step of determining one of the plurality of period lengths as a first period length. The adaptive filter updating step acquires, from the standard value storage unit 16, a first standard value corresponding to the first period length determined by the period length determining step, and updates the adaptive filter using the first standard value.

Since the plurality of standard values corresponding to the plurality of period lengths different from each other are stored in the standard value storage unit 16, the adaptive filter update step can immediately acquire the appropriate first standard value from the standard value storage unit 16 according to the determination of the period length determination step and update the adaptive filter. That is, the echo canceller 10 can immediately perform appropriate echo removal when an environment of the microphone 4 changes.

### Embodiment 2

In Embodiment 2, the same reference numerals are given to components that have been described in Embodiment 1, and description thereof may be omitted.

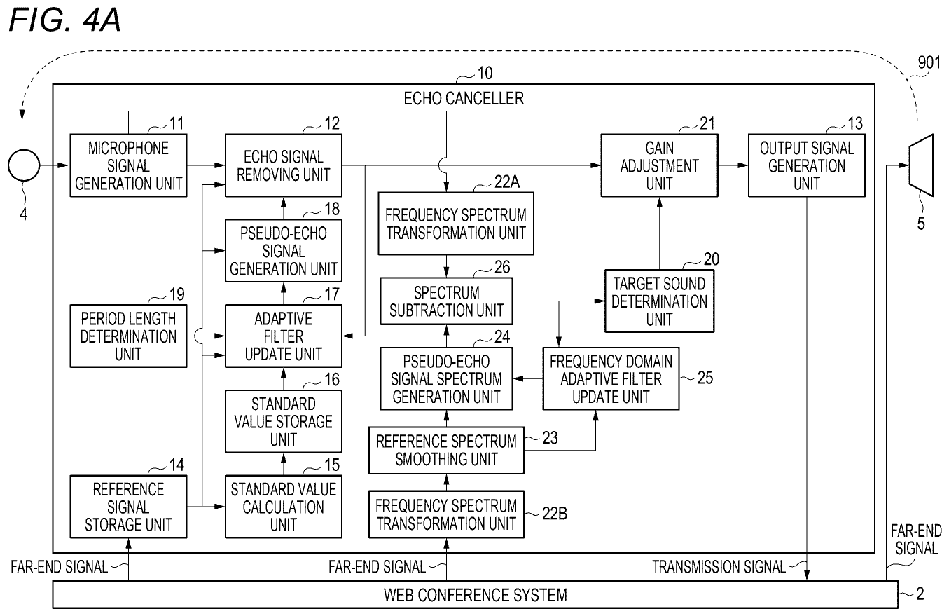

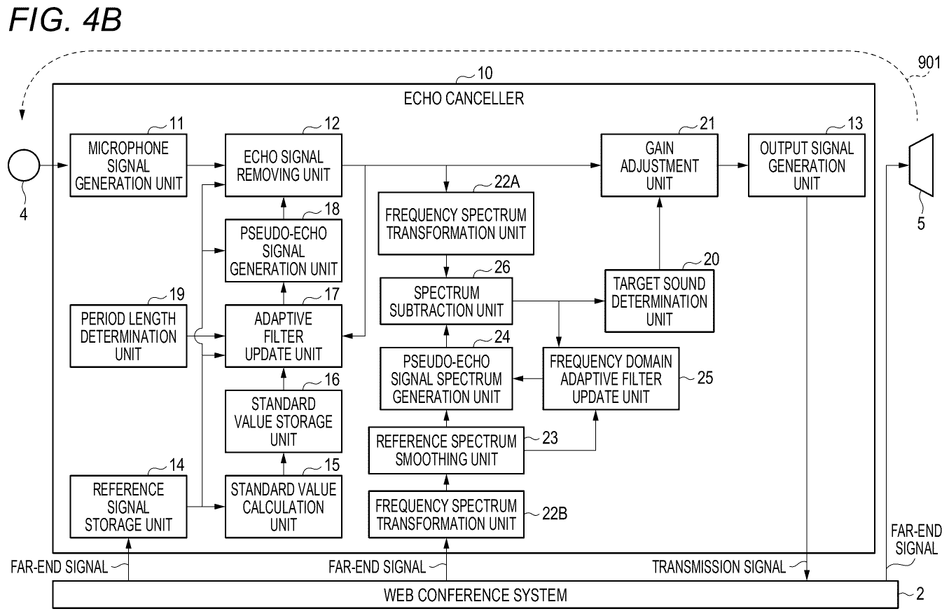

FIGS. 4A and 4B are block diagrams showing a configuration example of the echo canceller 10 according to Embodiment 2.

The echo canceller 10 includes the microphone signal generation unit 11, the echo signal removing unit 12, the output signal generation unit 13, the reference signal storage unit 14, the standard value calculation unit 15, the standard value storage unit 16, the adaptive filter update unit 17, the pseudo-echo signal generation unit 18, the period length determination unit 19, a target speech detection unit 20, a gain adjustment unit 21, a frequency spectrum transformation unit 22A, a frequency spectrum transformation unit 22B, a reference spectrum smoothing unit 23, a pseudo-echo signal spectrum generation unit 24, a frequency domain adaptive filter update unit 25, and a spectrum subtraction unit 26.

The target speech detection unit 20, the gain adjustment unit 21, the frequency spectrum transformation unit 22A, the frequency spectrum transformation unit 22B, the reference spectrum smoothing unit 23, the pseudo-echo signal spectrum generation unit 24, the frequency domain adaptive filter update unit 25, and the spectrum subtraction unit 26 may be implemented by a semiconductor circuit included in the echo canceller 10 or may be implemented by a computer program executed by a processor included in the echo canceller 10.

The microphone signal generation unit 11, the echo signal removing unit 12, the reference signal storage unit 14, the standard value calculation unit 15, the standard value storage unit 16, the adaptive filter update unit 17, the pseudo-echo signal generation unit 18, and the period length determination unit 19 have already been described in Embodiment 1, and thus description thereof will be omitted here.

The target speech detection unit 20 determines whether a target speech signal is included in an echo-removed signal output from the echo signal removing unit 12. The target speech signal is a signal of a speech transmitted to a far-end side and expected to be heard on the far-end side. For example, when a microphone input signal is m[i], a near-end speech signal is s[i], and an echo signal is y[i], m[i]=s[i]+y[i], and the target speech signal corresponds to s[i]. Here, s[i] is a speech voice of a near-end speaker to the microphone 4. Details of processing of the target speech detection unit 20 will be described later.

The gain adjustment unit 21 adjusts a gain of the echo-removed signal output from the echo signal removing unit 12 based on a determination result by the target speech detection unit 20, and outputs a gain-adjusted signal. For example, when the target speech detection unit 20 determines that the echo-removed signal includes the target speech signal, the gain adjustment unit 21 performs adjustment to amplify the gain of the echo-removed signal. Accordingly, a listener can hear a target sound or speech well. For example, when the target speech detection unit 20 determines that the echo-removed signal does not include the target speech signal, the gain adjustment unit 21 performs adjustment to attenuate the gain of the echo-removed signal. Accordingly, an echo sound that was not completely removed can be prevented from being transmitted unnecessarily loud to a far end. Details of processing of the gain adjustment unit 21 will be described later.

The output signal generation unit 13 generates and outputs a transmission signal based on the gain-adjusted signal output from the gain adjustment unit 21. The output signal generation unit 13 may directly output the gain-adjusted signal as the transmission signal, or may generate and output the transmission signal after performing prescribed processing on the gain-adjusted signal.

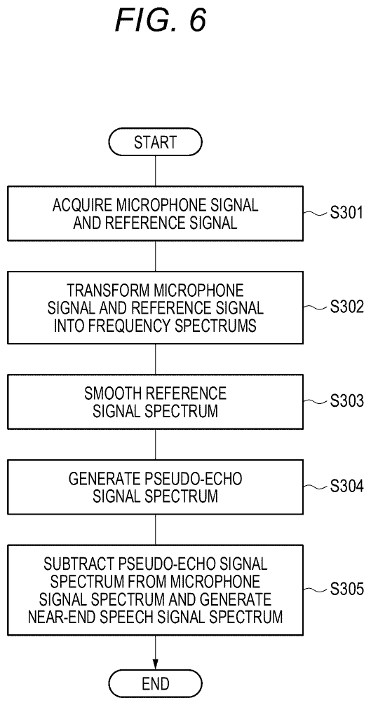

Processing of the frequency spectrum transformation unit 22A, the frequency spectrum transformation unit 22B, the reference spectrum smoothing unit 23, the pseudo-echo signal spectrum generation unit 24, the frequency domain adaptive filter update unit 25, and the spectrum subtraction unit 26 will be described later with reference to a flowchart shown in FIG. 6.

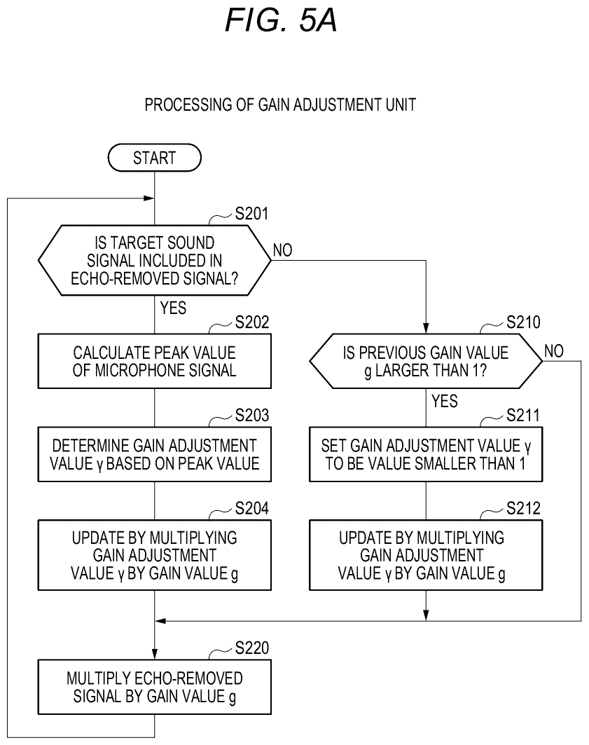

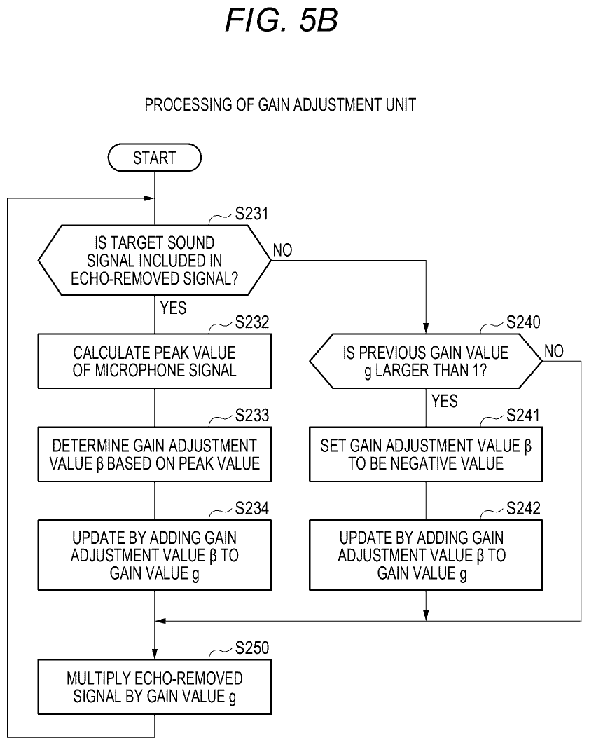

Next, the processing of the gain adjustment unit 21 will be described in detail. The gain adjustment unit 21 may perform the following processing of either FIG. 5A or FIG. 5B.

FIG. 5A is a flowchart showing a first example of the processing of the gain adjustment unit 21 according to Embodiment 2.

The gain adjustment unit 21 determines whether a target speech signal is included in an echo-removed signal based on a determination result by the target speech detection unit 20 (S201).

When the target speech signal is included in the echo-removed signal (S201: YES), the gain adjustment unit 21 executes the following processing.

The gain adjustment unit 21 calculates a peak value of the microphone signal m [i] (S202).

The gain adjustment unit 21 determines a gain adjustment value γ based on the peak value of the microphone signal calculated in step S202 (S203). For example, the gain adjustment unit 21 determines the gain adjustment value γ as a value smaller than 1 (for example, 0.9999) when the peak value of the microphone signal is larger than a prescribed threshold T1, and determines the gain adjustment value γ as a value larger than 1 (for example, 1.0001) when the peak value of the microphone signal is smaller than a prescribed threshold T2 (<T1).

Then, the gain adjustment unit 21 updates a gain value g by multiplying the determined gain adjustment value γ by the gain value g (S204). Then, the gain adjustment unit 21 advances the processing to step S220.

When the target speech signal is not included in the echo-removed signal (S201: NO), the gain adjustment unit 21 executes the following processing.

The gain adjustment unit 21 determines whether the previous gain value g is larger than 1 (S210).

When the previous gain value g is equal to or less than 1 (S210: NO), the gain adjustment unit 21 advances the processing to step S220.

When the previous gain value g is larger than 1 (S210: YES), the gain adjustment unit 21 sets the gain adjustment value γ to be a value smaller than 1 (for example, 0.9999). (S211).

Then, the gain adjustment unit 21 updates the gain value g by multiplying the determined gain adjustment value γ by the gain value g. Then, the gain adjustment unit 21 advances the processing to step S220.

The gain adjustment unit 21 multiplies the echo-removed signal by the gain value g, and generates and outputs a gain-adjusted signal (S220). Then, the gain adjustment unit 21 returns the processing to step S201.

According to the above processing, when the target speech signal is not included in the echo-removed signal, the gain adjustment value γ is smaller than 1. Accordingly, a level of the echo-removed signal gradually decreases by repeating the processing shown in FIG. 5A described above. That is, an echo sound remaining in the echo-removed signal without being completely removed is also gradually attenuated. Accordingly, a transmission signal containing an unnecessarily loud echo sound that was not completely removed can be prevented from being transmitted to the far-end side.

FIG. 5B is a flowchart showing a second example of the processing of the gain adjustment unit 21 according to Embodiment 2.

The gain adjustment unit 21 determines whether a target speech signal is included in an echo-removed signal based on a determination result by the target speech detection unit 20 (S231).

When the target speech signal is included in the echo-removed signal (S231: YES), the gain adjustment unit 21 executes the following processing.

The gain adjustment unit 21 calculates a peak value of the microphone signal m[i] (S232).

The gain adjustment unit 21 determines a gain adjustment value β based on the peak value of the microphone signal calculated in step S232 (S233). For example, the gain adjustment unit 21 determines the gain adjustment value β as a positive value (for example, “+0.0001”) when the peak value of the microphone signal is larger than the prescribed threshold T1, and determines the gain adjustment value β as a negative value (for example, “−0.0001”) when the peak value of the microphone signal is smaller than the prescribed threshold T2 (<T1).

Then, the gain adjustment unit 21 updates the gain value g by adding the determined gain adjustment value β to the gain value g (S234). Then, the gain adjustment unit 21 advances the processing to step S250.

When the target speech signal is not included in the echo-removed signal (S231: NO), the gain adjustment unit 21 executes the following processing.

The gain adjustment unit 21 determines whether the previous gain value g is larger than 1 (S240).

When the previous gain value g is equal to or less than 1 (S240: NO), the gain adjustment unit 21 advances the processing to step S250.

When the previous gain value g is larger than 1 (S240: YES), the gain adjustment unit 21 sets the gain adjustment value β to be a negative value (for example, “−0.0001”). (S241).

Then, the gain adjustment unit 21 updates the gain value g by adding the determined gain adjustment value β to the gain value g. Then, the gain adjustment unit 21 advances the processing to step S250.

The gain adjustment unit 21 multiplies the echo-removed signal by the gain value g, and generates and outputs a gain-adjusted signal (S250). Then, the gain adjustment unit 21 returns the processing to step S231.

According to the above processing, when the target speech signal is not included in the echo-removed signal, the gain adjustment value β is a negative value. Accordingly, a level of the echo-removed signal gradually decreases by repeating the processing shown in FIG. 5B described above. That is, an echo sound remaining in the echo-removed signal without being completely removed is also gradually attenuated. Accordingly, a transmission signal containing an unnecessarily loud echo sound that was not completely removed can be prevented from being transmitted to the far-end side.

FIG. 6 is a flowchart showing a processing example for removing an echo signal in a frequency domain according to Embodiment 2.

The frequency spectrum transformation unit 22A acquires a microphone signal from the microphone signal generation unit 11 (see FIG. 4A), and the frequency spectrum transformation unit 22B acquires a reference signal (S301).

The frequency spectrum transformation unit 22A transforms the microphone signal into a frequency spectrum, and the frequency spectrum transformation unit 22B transforms the reference signal into a frequency spectrum (S302). Hereinafter, the microphone signal transformed into a frequency spectrum is referred to as a microphone signal spectrum, and the reference signal transformed into a frequency spectrum is referred to as a reference signal spectrum. Here, a frequency spectrum represents a frequency domain signal obtained by transforming a time domain signal by a discrete Fourier transform or a fast Fourier transform, and represents a complex spectrum, an amplitude spectrum that is an absolute value thereof, or a power spectrum that is a square value thereof.

In steps S301 and S302, as shown in FIG. 4B, the frequency spectrum transformation unit 22A may acquire an echo-removed signal from the echo signal removing unit 12, transform the echo-removed signal into a frequency spectrum, and use the frequency spectrum as a microphone signal spectrum. By either of the methods shown in FIGS. 4A and 4B, the target speech detection unit 20 can determine whether a target sound or speech is present.

The reference spectrum smoothing unit 23 smooths the reference signal spectrum (S303). Here, smoothing represents processing of averaging a frequency spectrum in a time direction, and represents averaging processing generally executed on a time-series signal, such as moving averaging processing and exponential smoothing.

The pseudo-echo signal spectrum generation unit 24 generates a pseudo-echo spectrum corresponding to a frequency spectrum of a pseudo-echo signal using the smoothed reference signal spectrum and a frequency domain adaptive filter. The frequency domain adaptive filter update unit 25 updates the frequency domain adaptive filter based on the smoothed reference signal spectrum and a spectrum after subtraction calculated by the spectrum subtraction unit 26. The frequency domain adaptive filter is generally updated using an adaptive algorithm such as LMS, NLMS, APA, and RLS or a sound source separation algorithm such as ICA and IVA so that the frequency spectrum after subtraction is minimized.

The spectrum subtraction unit 26 subtracts the pseudo-echo signal spectrum from the microphone signal spectrum and generates a near-end speech signal spectrum corresponding to a frequency spectrum of a near-end speech signal (S305). Here, the near-end speech signal is a signal of a speech of a speaker input to the microphone 4 on a near-end side, and corresponds to a target speech signal.

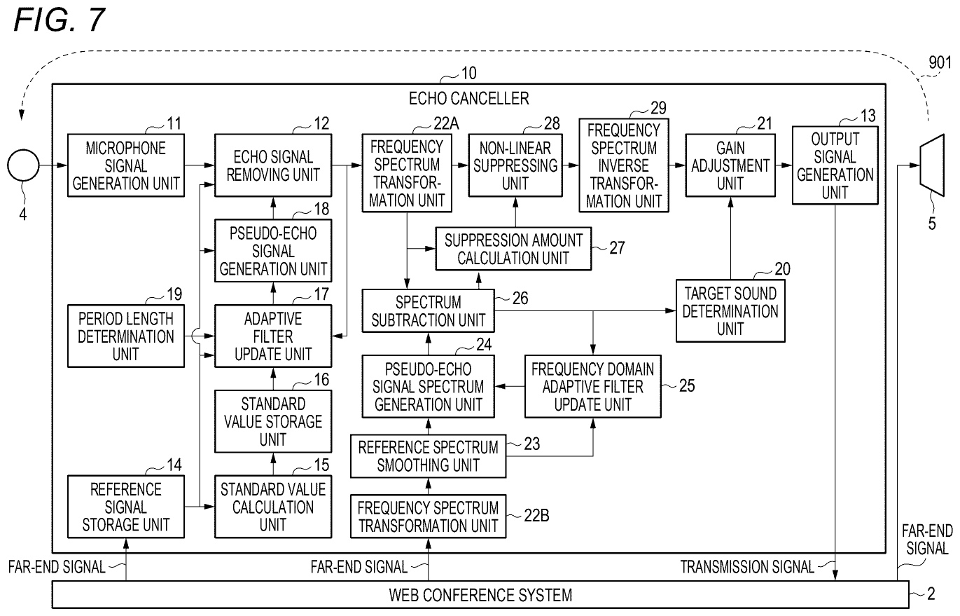

As shown in FIG. 7, a non-linear suppressing unit 28 and a frequency spectrum inverse transformation unit 29 may be provided at a subsequent stage of the frequency spectrum transformation unit 22A, and a suppression amount calculation unit 27 that calculates a suppression amount used by the non-linear suppressing unit 28 may be provided. The suppression amount calculation unit 27 calculates the suppression amount used by the non-linear suppressing unit 28 based on a frequency spectrum obtained by the frequency spectrum transformation unit 22A and a frequency spectrum obtained by the spectrum subtraction unit 26. The suppression amount is calculated by a general method such as a spectrum subtraction method or a Wiener filter. The non-linear suppressing unit 28 performs nonlinear suppression by multiplying a complex spectrum in a frequency domain obtained by the frequency spectrum transformation unit 22A by the suppression amount obtained by the suppression amount calculation unit 27. The complex spectrum subjected to the nonlinear suppression is input to the frequency spectrum inverse transformation unit 29. The frequency spectrum inverse transformation unit 29 executes processing of transforming an input complex spectrum signal into a time domain signal, which is obtained by a discrete inverse Fourier transform or a fast inverse Fourier transform.

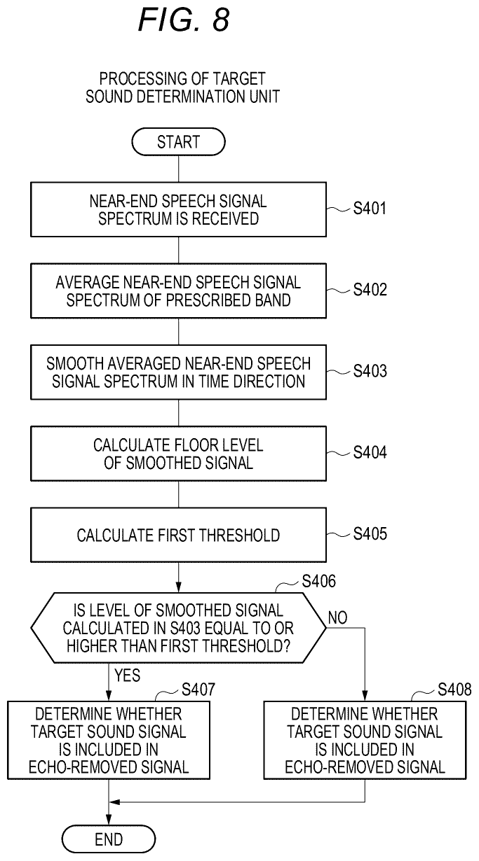

FIG. 8 is a flowchart showing a processing example of the target speech detection unit 20 according to Embodiment 2.

This processing may be executed after the processing shown in FIG. 6.

The target speech detection unit 20 receives a near-end speech signal spectrum generated by the spectrum subtraction unit 26 (S401).

The target speech detection unit 20 averages the near-end speech spectrum of a prescribed band (S402). Here, the prescribed band is a band including a human speech spectrum, and may be, for example, 0.5 kHz to 4 kHz.

The target speech detection unit 20 smooths the averaged near-end speech signal spectrum in a time direction and generates a smoothed signal (S403). Here, the smoothing may be calculated as an arithmetic mean of exponential smoothed outputs based on a time constant of a first time (short time) and a time constant of a second time (long time) longer than the first time. Smoothing for a short time serves to quickly detect a rise of a signal, and smoothing for a long time serves to slowly detect a fall of the signal.

The target speech detection unit 20 calculates a noise floor level of the smoothed signal (S404).

The target speech detection unit 20 calculates a first threshold based on the smoothed signal and the noise floor level (S405). For example, the target speech detection unit 20 sets a value obtained by adding a prescribed second threshold to the noise floor level calculated in step S404 or a value larger than the value as the first threshold.

The target speech detection unit 20 determines whether a level of the smoothed signal calculated in step S403 is equal to or higher than the first threshold (S406).

When the level of the smoothed signal calculated in step S403 is equal to or higher than the first threshold (S406: YES), the target speech detection unit 20 determines that the target speech signal is included in the echo-removed signal (S407), and ends the processing.

When the level of the smoothed signal calculated in step S403 is less than the first threshold (S406: NO), the target speech detection unit 20 determines that the target speech signal is not included in the echo-removed signal (S408), and ends the processing.

The target speech detection unit 20 may determine whether the target speech signal is included in the echo-removed signal by the following method. That is, the target speech detection unit 20 may determine that the target speech signal is included in the echo-removed signal when a difference between a level of a microphone signal and a level of an echo-removed signal is less than a prescribed third threshold, and may determine that the target speech signal is not included in the echo-removed signal when the difference is equal to or larger than the third threshold.

Through the above processing, the target speech detection unit 20 can determine whether the target speech signal is included in the echo-removed signal. Further, by executing the processing in the frequency domain, it is easy to adjust and determine a spectrum in a prescribed band.

### Summary of Embodiment 2

The following techniques are disclosed in Embodiment 2.

### <Technique B1>

The echo canceller 10 for removing an echo sound, which is a sound output from the speaker 5, propagates through space and is input to the microphone 4, includes: the microphone signal generation unit 11 that generates a microphone signal based on a sound received from the microphone 4: the adaptive filter update unit 17 that updates an adaptive filter used for estimating an echo signal that is a signal related to the echo sound: the pseudo-echo signal generation unit 18 that generates a pseudo-echo signal based on an output signal that is a signal related to a speech output from the speaker 5 and the adaptive filter; the echo signal removing unit 12 that removes the pseudo-echo signal from the microphone signal and generates an echo-removed signal: the target speech detection unit 20 that determines whether a target speech signal that is a signal different from the echo signal is included in the echo-removed signal; the gain adjustment unit 21 that adjusts a gain of the echo-removed signal based on a determination result by the target speech detection unit 20; and the output signal generation unit 13 that generates the output signal based on the echo-removed signal adjusted by the gain adjustment unit 21.

Accordingly, a gain can be adjusted according to whether a target speech signal is included in an echo-removed signal.

### <Technique B2>

In the echo canceller 10 described in technique B1, the target speech detection unit 20 determines that the target speech signal is included in the echo-removed signal when a level of a smoothed signal obtained by smoothing the echo-removed signal in a prescribed period is equal to or larger than a prescribed first threshold.

Accordingly, the target speech detection unit 20 can determine whether the target speech signal is included in the echo-removed signal.

### <Technique B3>

In the echo canceller 10 described in technique B2, the first threshold is a value obtained by adding a prescribed second threshold to a noise floor level of the smoothed signal or a value larger than the above value.

This makes it possible to determine the first threshold used to determine whether the target speech signal is included in the echo-removed signal.

### <Technique B4>

In the echo canceller 10 described in technique B1, the target speech detection unit 20 determines that the target speech signal is included in the echo-removed signal when a difference between a level of the microphone signal and a level of the echo-removed signal is less than a prescribed third threshold, while the target speech detection unit 20 determines that the target speech signal is not included in the echo-removed signal when the difference is equal to or larger than the third threshold.

Accordingly, the target speech detection unit 20 can determine whether the target speech signal is included in the echo-removed signal.

### <Technique B5>

In the echo canceller 10 described in any one of technique B1 to technique B4, when the determination result indicates that the target speech signal is not included in the echo-removed signal, the gain adjustment unit 21 performs adjustment to attenuate the gain of the echo-removed signal.

Accordingly, the gain of the echo-removed signal that does not include the target speech signal is attenuated. Therefore, a transmission signal including an unnecessarily amplified echo signal remaining in an echo-removed signal can be prevented from being transmitted to a far-end side.

### <Technique B6>

In the echo canceller 10 described in any one of technique B1 to technique B5, when the determination result indicates that the target speech signal is included in the echo-removed signal, the gain adjustment unit 21 determines amplification or attenuation of the gain of the echo-removed signal based on a peak value of the microphone signal.

Accordingly, the gain of the echo-removed signal including the target speech signal is appropriately adjusted. Therefore, a listener can hear a target sound or a target speech well.

### <Technique B7>

The echo canceller 10 described in technique B1 further includes the frequency spectrum transformation unit 22A that acquires the echo-removed signal from the echo signal removing unit 12 and transforms the echo-removed signal into a frequency spectrum, and the target speech detection unit 20 determines whether the target speech signal is included in the echo-removed signal based on the frequency spectrum.

Accordingly, the target speech detection unit 20 can determine whether the target speech signal is included in the echo-removed signal.

### <Technique B8>

An echo cancellation method for removing an echo sound, which is a sound output from the speaker 5, propagates through space and is input to the microphone 4, includes: a microphone signal generation step of generating a microphone signal based on a sound received from the microphone 4: an adaptive filter update step of updating an adaptive filter used for estimating an echo signal that is a signal related to the echo sound: a pseudo-echo signal generation step of generating a pseudo-echo signal based on an output signal that is a signal related to a sound output from the speaker 5 and the adaptive filter: an echo signal removing step of removing the pseudo-echo signal from the microphone signal and generating an echo-removed signal: a target speech determination step of determining whether a target speech signal that is a signal different from the echo signal is included in the echo-removed signal: a gain adjustment step of adjusting a gain of the echo-removed signal based on a determination result by the target speech determination step; and an output signal generation step of generating the output signal based on the echo-removed signal adjusted by the gain adjustment step.

Accordingly, a gain can be adjusted according to whether a target speech signal is included in an echo-removed signal.

Although the embodiments have been described above with reference to the accompanying drawings, the present disclosure is not limited thereto. It is apparent to those skilled in the art that various modifications, corrections, substitutions, additions, deletions, and equivalents can be conceived within the scope described in the claims, and it is understood that such modifications, corrections, substitutions, additions, deletions, and equivalents also fall within the technical scope of the present disclosure. In addition, components in the embodiments described above may be combined freely in a range without departing from the gist of the invention.

The present application is based on Japanese Patent Application No. 2022-155170 filed on Sep. 28, 2022, and contents thereof are incorporated herein by reference.

### INDUSTRIAL APPLICABILITY

The technique of the present disclosure is useful for a system and a device including a microphone and a speaker, a method for processing a speech signal received from the microphone in the system and the device, a computer program, and the like.

### REFERENCE SIGNS LIST

1 speech input and output system
2 WEB conference system
3 rack mount mixer
4 microphone
5 speaker
10 echo canceller
11 microphone signal generation unit
12 echo signal removing unit
13 output signal generation unit
14 reference signal storage unit
15 standard value calculation unit
16 standard value storage unit
17 adaptive filter update unit
18 pseudo-echo signal generation unit
19 period length determination unit
20 target speech detection unit
21 gain adjustment unit
31 ring buffer
40 tap length L0 norm value calculation unit
41 tap length L1 norm value calculation unit
42 tap length L2 norm value calculation unit
43 tap length L3 norm value calculation unit
901 dotted arrow

1. An echo canceller for removing an echo sound that is a sound output from a speaker, propagates through space and is input to a microphone, the echo canceller comprising:
a microphone signal generation unit that generates a microphone signal based on a sound received from the microphone;
an adaptive filter update unit that updates an adaptive filter used for estimating an echo signal that is a signal related to the echo sound;
a pseudo-echo signal generation unit that generates a pseudo-echo signal based on an output signal that is a signal related to a sound output from the speaker and the adaptive filter;
an echo signal removing unit that removes the pseudo-echo signal from the microphone signal and generates an echo-removed signal;
a target speech detection unit that determines whether a target speech signal that is a signal different from the echo signal is included in the echo-removed signal;
a gain adjustment unit that adjusts a gain of the echo-removed signal based on a determination result by the target speech detection unit; and
an output signal generation unit that generates the output signal based on the echo-removed signal adjusted by the gain adjustment unit.

2. The echo canceller according to claim 1, wherein
the target speech detection unit determines that the target speech signal is included in the echo-removed signal when a level of a smoothed signal obtained by smoothing the echo-removed signal in a prescribed period is equal to or larger than a prescribed first threshold.

3. The echo canceller according to claim 2, wherein
the first threshold is a value obtained by adding a prescribed second threshold to a noise floor level of the smoothed signal or a value larger than the above value.

4. The echo canceller according to claim 1, wherein
in a case that a difference between a level of the microphone signal and a level of the echo-removed signal is less than a prescribed third threshold, the target speech detection unit determines that the target speech signal is included in the echo-removed signal, and
in a case that the difference is equal to or larger than the third threshold, the target speech detection unit determines that the target speech signal is not included in the echo-removed signal when the difference is equal to or larger than the third threshold.

5. The echo canceller according to claim 1, wherein
when the determination result indicates that the target speech signal is not included in the echo-removed signal, the gain adjustment unit performs adjustment to attenuate the gain of the echo-removed signal.

6. The echo canceller according to claim 1, wherein
when the determination result indicates that the target speech signal is included in the echo-removed signal, the gain adjustment unit determines amplification or attenuation of the gain of the echo-removed signal based on a peak value of the microphone signal.

7. The echo canceller according to claim 1, further comprising:
a frequency spectrum transformation unit that acquires the echo-signal-removed signal from the echo signal removing unit and transforms the echo-removed signal into a frequency spectrum, and
the target speech detection unit determines whether the target speech signal is included in the echo-removed signal based on the frequency spectrum.

8. An echo cancellation method for removing an echo sound that is a sound output from a speaker, propagates through space and is input to a microphone, the method comprising:
generating a microphone signal based on a sound received from the microphone;
updating an adaptive filter used for estimating an echo signal that is a signal related to the echo sound;
generating a pseudo-echo signal based on an output signal that is a signal related to a sound output from the speaker and the adaptive filter;
removing the pseudo-echo signal from the microphone signal and generating an echo-removed signal;
determining whether a target speech signal that is a signal different from the echo signal is included in the echo-removed signal;
adjusting a gain of the echo-removed signal based on a determination result obtained during the determining; and
generating the output signal based on the echo-removed signal adjusted during the adjusting.
